(19) United States
(12) Patent Application Publication
(10) Pub. No.: US 2006/0060931 A1
(43) Pub. Date: Mar. 23, 2006

(54) Standard micro-component for calibrating or standardizing fluorescence measuring instruments and biochip comprising same

(75) Inventors: Martine Cochet, Moirans (FR); Francois Perraut, Saint Joseph de Riviere (FR); Patrick Pouteau, Meylan (FR); Frederic Revol-Cavalier, Seyssins (FR)

Correspondence Address: OLIFF & BERRIDGE, PLC, P.O. BOX 19928, ALEXANDRIA, VA, 22320, US

(73) Assignees: Commissariat A L'energie Atomique, Paris (FR); Biomeriex, Marcy L'Etoile (FR)

(21) Appl. No.: 10/538,866

(22) PCT Filed: Dec. 10, 2003
(86) PCT No.: PCT/FR03/03656

§ 371 Date: Jun. 14, 2005

(30) Foreign Application Priority Data
Dec. 17, 2002 (FR) 02 16012

(51) Int. Cl. G01J 1/10

(52) U.S. Cl. 257/414; 356/243.1; 250/526

(57) ABSTRACT

The invention concerns a standard micro-component (4) for calibrating or standardizing fluorescence measuring instruments, comprising a substrate (1) whereon is arranged at least one thin film (2). The thin film (2) includes fluorescent components. At least one first zone (3) of null thickness is formed in the thin film (2), thereby exposing the substrate (1). The thin film (2) comprises at least one exposed zone (2a), such that first and second fluorescence levels are respectively defined in the non exposed part and in the exposed part (2a) of the thin film (2). The second fluorescence level is lower than the first fluorescence level. The standard micro-component (4) can also include a plurality of stacked thin films so as to define a plurality of fluorescence levels.

### BACKGROUND OF THE INVENTION

The invention relates to a standard micro-component for calibrating and standardizing fluorescence measuring instruments comprising a substrate whereon there is arranged at least one thin layer comprising fluorescent components, said micro-component comprising at least first and second fluorescence levels.

The invention also relates to a biochip comprising said micro-component.

The invention also relates to a process for fabricating said micro-component comprising deposition on a substrate of at least one thin layer comprising fluorescent components.

### State of the Art

A known standard micro-component (FIG. 1) comprises a non-fluorescent glass substrate 1 whereon a layer 2 of fluorescent organic material having a thickness of 3 microns is deposited. It also comprises openings 3 formed in the layer 2 by etching. This type of micro-component enables a fluorescence level corresponding to that of the layer 2 to be obtained. However the openings 3 have a width of approximately 4 microns and are spaced 8 microns apart from one another, which is not satisfactory for calibration of the instruments generally used.

The document WO-A-0,159,503 describes a standard micro-component comprising a fluorescent layer deposited on a substrate. It is generally used to establish a reference base between different microscopes and to characterize an image quality, for example in terms of resolution, contrast, field depth and distortion. The layer is covered by a thin, non-fluorescent mask comprising openings. The mask and fluorescent layer are pressed against one another, which requires three fabrication operations: fabrication of the layer, fabrication of the mask and assembly thereof. Moreover, as the mask and layer are made of two different materials, they can not be placed on the same optical plan, as this would be liable to deform the optical image of the observed zone.

The document DE-A-10,200,865 describes a standard for detecting fluorescence, the standard comprising several fluorescence levels respectively defined by zones of different thicknesses. Each zone of predetermined thickness corresponds to stacking of a predetermined number of thin polymer layers. In addition, the fluorescence characteristic of a thin layer depends on the reticulation level of the thin polymer layer, the reticulation level being obtained by exposure of the thin layer during a photolithography step. It is also indicated that the oxidation phenomenon of fluorescent components due to exposure (phenomenon called Bleaching) is a detrimental phenomenon that is avoided in the standard instrument described in the document DE-A-10,200,865. Such a standard is however not very practical to implement, as fabrication thereof requires a succession of long and tedious steps and the standard thus achieved may prove cumbersome.

### OBJECT OF THE INVENTION

It is an object of the invention to provide a standard micro-component not presenting the drawbacks of standard prior art micro-components and that is easy to fabricate.

According to the invention, this object is achieved by the appended claims.

More particularly, this objective is achieved by the fact that the first and second fluorescence levels are respectively defined by a non-exposed part and by at least one exposed zone of said thin layer, the second fluorescence level being lower than the first fluorescence level.

According to a development of the invention, the thin layer comprises at least one opening defining a third fluorescence level lower than the first and second fluorescence levels.

According to a preferred embodiment, the thin layer comprises a plurality of exposed zones so as to define a plurality of different fluorescence levels.

According to another feature of the invention, the standard micro-component comprises a plurality of stacked thin layers so as to define a plurality of fluorescence levels.

It is also an object of the invention to provide a biochip comprising, on a single substrate, at least one biological sensor and at least one standard micro-component as described above.

It is also an object of the invention to provide a fabrication process of such a standard micro-component.

According to the invention, this object is achieved by the fact that the process consists in exposing at least one zone of the thin layer so that first and second fluorescence levels are respectively defined by the non-exposed part and by the exposed zone of the thin layer.

### BRIEF DESCRIPTION OF THE DRAWINGS

Other advantages and features will become more clearly apparent from the following description of particular embodiments of the invention given as nonrestrictive examples only and represented in the accompanying drawings, in which:

FIG. 1 is a schematic representation of a standard micro-component according to the prior art.

FIG. 2 schematically represents a first embodiment of a standard micro-component according to the invention.

FIGS. 3 and 4 represent a second embodiment of a standard micro-component according to the invention, respectively before and after etching of a second thin layer.

FIG. 5 is a schematic representation of a biochip comprising a standard micro-component according to the invention.

FIGS. 6 and 7 represent third and fourth embodiments of a standard micro-component comprising a protective thin layer according to the invention.

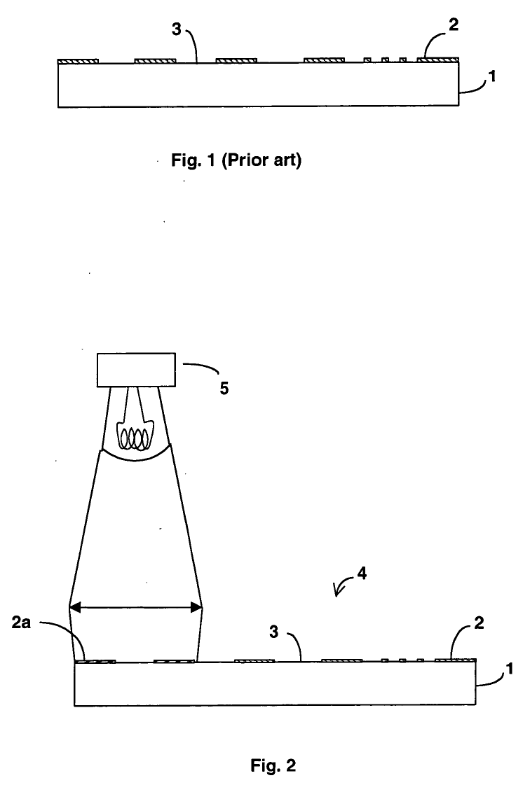

### DESCRIPTION OF PARTICULAR EMBODIMENTS

In FIG. 2, a standard micro-component 4 designed for calibrating or standardizing fluorescence measuring instruments, such as confocal or non-confocal fluorescence microscopes, comprises a non-fluorescent substrate 1 whereon at least one thin layer or film 2 is deposited. The substrate 1 is preferably constituted by a material selected from the group consisting of silicon, silica, quartz, plastics and glasses.

The thin layer 2 comprises fluorescent components defining a first fluorescence level. It can be made of fluorescent material or comprise fluorescent particles or molecules. Thus, it can be constituted by a photosensitive resin that is fluorescent or contains fluorescent particles, such as Duramide® 7505 marketed by the OLIN Microelectronic Material corporation.

The thin layer 2 is deposited on the substrate 1 by any type of known process. For example, it can be deposited by a Low Pressure Chemical Vapor Deposition (LPCVD) or by a Plasma Enhanced Chemical Vapor Deposition (PECVD) process. The thin layer 2 can also be achieved by deposition of tetraethoxysilane (Si(OC₂H₅)₄ or TEOS) by a deposition process of a photoresist layer achieved by centrifugation and called spin-coating, by a localized resin deposition (lift-off process), by evaporation, by sputtering or by dip-coating and drawing.

The thin layer 2 preferably comprises at least one opening 3 freeing the surface of the substrate 1. In FIG. 2, seven openings 3 are formed in the thin layer 2 and define a second fluorescence level corresponding to the fluorescence level of the substrate 1. The fluorescence level of the substrate is at least 10 times lower than the first fluorescence level of the thin layer 2, and preferably 100 times lower than the first fluorescence level. The openings 3 form patterns and they are achieved by any type of known means. They are, for example, formed by etching, by photolithography, by photolithography followed by etching (lift-off process). Thus, for a thin layer 2 made of photosensitive resin, the openings 3 are preferably achieved by a conventional photolithography step (exposure followed by chemical developing).

The thin layer 2 comprises at least one zone 2a exposed by a light source 5, which is for example a mercury vapor lamp. Two exposed zones 2a are represented in FIG. 2. Exposure of the zones 2a of the thin layer 2 causes oxidation of the fluorescent components of the thin layer 2 reducing their fluorescence characteristics. This phenomenon better known as bleaching is generally considered to be detrimental. In spite of this prejudice, this phenomenon is, according to the invention, used to reduce the fluorescence characteristics of the thin layer 2 at the level of the zones 2a in controlled manner, and therefore to reduce the fluorescence level of the zones 2a. The thin layer 2 thus presents two distinct fluorescence levels defined by the non-exposed part of the thin layer 2 and by the exposed zones 2a.

The zones 2a then have an intermediate fluorescence level, lower than the first fluorescence level defined by the non-exposed part of the non-exposed thin layer 2 and, in the example described, higher than the second fluorescence level of the openings 3. The choice of the parameters such as the wavelength, power and time period of the light radiation emitted by the light source 5 determine the intermediate fluorescence level so that it is lower than the first fluorescence level of the non-exposed thin layer and higher than the second fluorescence level, i.e. generally not zero. These parameters are adjusted according to the type of material forming the thin layer and the thickness of the latter. For example, the fluorescence level of a thin layer of Duramide® 7505 resin with a thickness of about 10 microns can be reduced by half by exposing the thin layer with a mercury vapor lamp with a power of 14,500 W/m² and an exposure time of 240 minutes.

The micro-component 4 presents the advantage of being easy to achieve. The techniques implemented are in fact techniques used in microelectronics which enable pattern dimensions of about 0.3 μm to be achieved. They enable a large number of standard micro-components to be fabricated collectively on a single substrate and the number of fabrication steps is limited. Thus, according to the invention, a fabrication process of a micro-component consists in depositing on a substrate at least one thin layer comprising fluorescent components and in exposing at least one zone of the thin layer so that first and second fluorescence levels are respectively defined by the non-exposed part and by the exposed part of the thin layer.

According to a first alternative embodiment, the thin layer 2 can comprise a plurality of exposed zones so as to define a plurality of different intermediate fluorescence levels. The intermediate fluorescence levels are determined according to the global local exposure characteristics (exposure power and time). These global characteristics are obtained in the course of one or more successive, independent or complementary, exposures.

According to another alternative embodiment, the standard micro-component can comprise in addition a plurality of stacked thin layers able to be totally, partially or non-exposed, so as to define a plurality of fluorescence levels. Each thin layer comprises at least one opening 3 and the openings 3 of at least two layers can be superposed. The fabrication process of such a micro-component then comprises deposition, on the substrate, of a plurality of stacked thin layers. This presents the advantage of achieving a standard micro-component having dimensions equivalent to those of the objects read by the reader which is to be calibrated or standardized. In particular, the thickness of the fluorescent material constituting the patterns is close to that of the zones to be measured on biochips for example. This enables the reader to be calibrated under optical conditions equivalent to those of usual readings. The thickness of the standard micro-component is preferably less than 50 microns, and even as low as 10 microns.

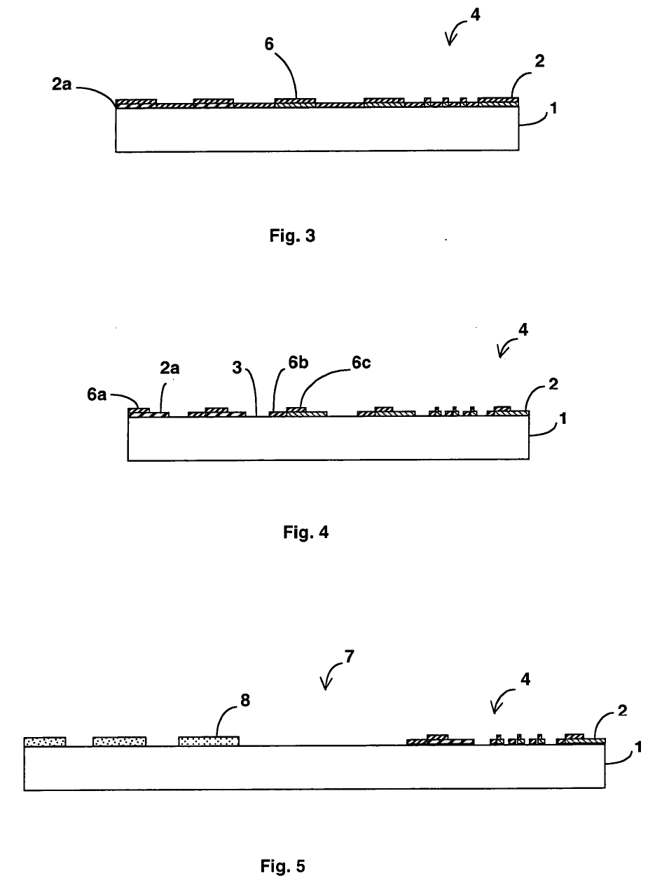

Thus, in FIG. 3, a second thin layer 6 is deposited by any suitable type of means on the standard micro-component 4 comprising a first layer 2 such as the one described in FIG. 2. The second layer 6 then covers the openings 3, the first thin layer 2 and the exposed zones 2a. The first and second layers 2 and 6 have distinct fluorescence characteristics either by the nature of the respective fluorescent components which they contain or by their respective fluorescent component concentrations.

A part of the second layer 6 is then removed (FIG. 4) by any suitable type of means so as to form zones 6a, 6b and 6c respectively covering a part of the zones 2a of the first thin layer 2, a part of the openings 3 and a part of the thin layer 2. The zones 6b define a third fluorescence level corresponding to the fluorescence characteristic of the second thin layer 6. As accumulation of several fluorescent thin layers on one another increases the fluorescence level accordingly, the zones 6a and 6c, respectively superposed on the zones 2a and on the thin layer 2, define a fourth and fifth fluorescence level. The fourth and fifth fluorescence levels are higher than the highest fluorescence level of the non-exposed first and second layers 2 and 6. The standard micro-component 4 according to FIG. 4 then comprises five different fluorescence levels.

The standard micro-component can be achieved on a substrate whereon biological sensors are then achieved. Thus, in FIG. 5, a biochip 7 comprises a substrate 1 whereon biological sensors 8 and the standard micro-component 4 are deposited. It is then possible to achieve biochips comprising at least one standard micro-component and at least one biological sensor on a single substrate.

The fluorescence levels of the standard micro-component can also be stabilized in time by arranging by deposition, after exposure, at least one protective thin layer on at least a part of the thin layers of the standard micro-component. The protective thin layer enables at least a part of the thin layers to be isolated from the external environment.

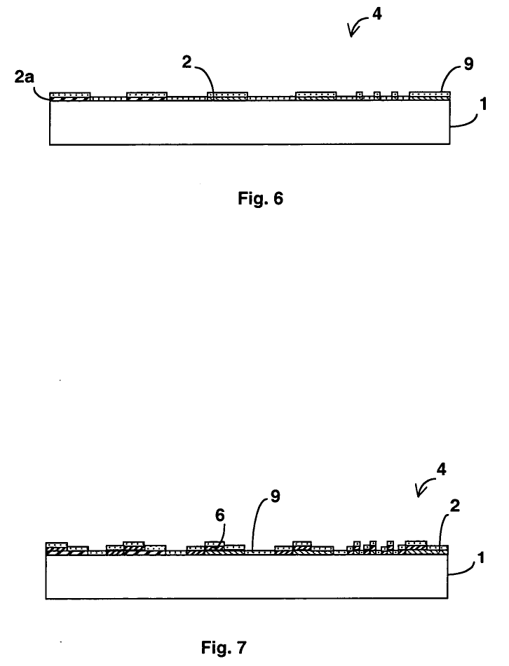

As an example represented in FIG. 6, a micro-component 4 of the type represented in FIG. 2 comprises a non-fluorescent substrate 1 whereon at least a first structured thin layer 2 is deposited. The thin layer 2 can also be formed by biological molecules marked by fluorescent particles or molecules. In this case, this layer is achieved and defined by any type of process known in the biochip field (functionalization, hybridization, adsorption, etc.). The micro-component comprising this type of thin layer can then act as reference biochip.

The first thin layer 2 is covered by a protective thin layer 9 designed to isolate the first thin layer 2 from the external environment in which the micro-component 4 is situated. The external environment is generally air. Thus, the protective layer 9 prevents oxidization of the fluorescent components contained in the thin layer 2, which makes the fluorescent components stable in time.

The protective layer can be opaque or semi-transparent when reading of the micro-component is performed through the substrate. The substrate is then transparent to the optical reading signals and can for example be made of glass, silica or plastic. On the contrary, in the case where reading of the micro-component is performed on the opposite side of the substrate, the protective layer 9 has to be transparent to the optical reading signals received and sent back by the first thin layer 2. This enables the fluorescence phenomenon to be excited and observed without disturbing it.

The protective thin layer 9 is achieved by any type of process suited to the requirements of the protective layer 9. For example, it can be achieved by a LPCVD process, a PECVD process, evaporation, sputtering or spin-coating. Advantageously, the protective layer 9 can be structured by any type of means known in micro-electronics so as to cover, for example, at least a part of the fluorescent zones.

According to an alternative embodiment, the thin layer 2 can be covered by a plurality of stacked protective thin layers. In addition, the protective thin layer(s) can be used to enhance the fluorescence characteristics of the thin layer 2. In this case, the protective thin layers can be of the same type as the thin layers described in the document WO-A-0,248,691. In particular, the material forming the protective thin layer can be selected from the group consisting of the following materials: TiO₂, Ta₂O₅, HfO₂, ZrO₂, MgO, SiO₂, Si₃N₄, MgF₂, and YF₃, Al₂O₃, ZrO₄T₁, Y₂O₃, diamond and oxynitrides. In addition, the thickness of the protective thin layer or of each protective thin layer is preferably calculated using the following formula: n.e=k.λ/4, in which n is the refractive index of the material composing the protective thin layer for a wavelength λ of the optical reading signal received by the first thin layer, e is the optical thickness of the protective thin layer and k is an odd integer. The optical thickness corresponds to the product of the refractive index n with the thickness of the thin layer considered, for the wavelength considered.

As represented in FIG. 7, the standard micro-component can, as in FIG. 4, comprise a plurality of stacked thin layers 2 and 6 so as to define a plurality of fluorescence levels. After structuring of the thin layer 6, the protective thin layer 9 is deposited on the micro-component 4 so as to totally cover, for example, the layers 2 and 6 and the uncovered parts of the substrate 1. The micro-component 4, in particular designed for calibrating or standardizing fluorescence measuring instruments, then comprises several fluorescence levels protected against the external environment.

The use of a protective thin layer enables micro-components such as standard chips or standard micro-components to be achieved having fluorescence characteristics that are stable with time, which enables comparisons to be made between several measurements staggered in time or between different measuring instruments, with respect to a reference which does not undergo variations with time.

The invention is not limited to the embodiments described above. Thus, at least a part of the second thin layer 6 can also be exposed, at the same time as, before or after the zones 2a, with different or identical exposure parameters such as wavelength, exposure time or power.

1-20. (canceled)

21. Standard micro-component for calibrating and standardizing fluorescence measuring instruments comprising a substrate whereon there is arranged at least one thin layer comprising fluorescent components, said micro-component comprising at least first and second fluorescence levels, micro-component wherein the first and second fluorescence levels are respectively defined by a non-exposed part and by at least one exposed zone of said thin layer, the second fluorescence level being lower than the first fluorescence level.

22. Standard micro-component according to claim 21, wherein the thin layer comprises at least one opening defining a third fluorescence level lower than the first and second fluorescence levels.

23. Standard micro-component according to claim 22, wherein the third fluorescence level corresponds to the fluorescence level of the substrate.

24. Standard micro-component according to claim 22, wherein the third fluorescence level is at least 10 times lower than the first fluorescence level.

25. Standard micro-component according to claim 24, wherein the third fluorescence level is at least 100 times lower than the first fluorescence level.

26. Standard micro-component according to claim 21, wherein the thin layer is formed by a fluorescent material.

27. Standard micro-component according to claim 21, wherein the thin layer comprises a plurality of exposed zones so as to define a plurality of different fluorescence levels.

28. Standard micro-component according to claim 21, wherein the thin layer is formed by a photosensitive resin.

29. Standard micro-component according to claim 21, wherein the substrate is formed by a material selected from the group consisting of silicon, synthetic silica, quartz, plastics and glasses.

30. Standard micro-component according to claim 21, wherein at least a part of the thin layer is covered by a protective thin layer.

31. Standard micro-component according to claim 30, wherein the protective thin layer is transparent to optical reading signals received and sent back by the thin layer.

32. Standard micro-component according to claim 30, wherein the micro-component comprises a plurality of stacked protective thin layers.

33. Standard micro-component according to claim 30, wherein the material forming the protective thin layer is selected from the group consisting of the following materials: TiO₂, Ta₂O₅, HfO₂, ZrO₂, MgO, SiO₂, Si₃N₄, MgF₂, YF₃, Al₂O₃, ZrO₄T₁, Y₂O₃, diamond and oxynitrides.

34. Standard micro-component according to claim 30, wherein the thickness of the protective thin layer is calculated using the following formula: n.e=kλ/4, in which n is the refractive index of the material composing the protective thin layer for a wavelength λ of the optical reading signal received by the thin layer, e is the optical thickness of the protective thin layer and k is an odd integer.

35. Standard micro-component according to claim 21, wherein the standard micro-component comprises a plurality of stacked thin layers so as to define a plurality of fluorescence levels.

36. Standard micro-component according to claim 35, wherein the openings of at least two thin layers are superposed.

37. Biochip comprising, on a single substrate, at least one biological sensor and at least one standard micro-component according to claim 21.

38. Fabrication process of a standard micro-component according to claim 21, comprising deposition on a substrate of at least one thin layer comprising fluorescent components, process consisting in exposing at least one zone of the thin layer so that first and second fluorescence levels are respectively defined by the non-exposed part and by the exposed zone of the thin layer.

39. Fabrication process of a standard micro-component according to claim 38, comprising deposition, on the substrate, of a plurality of stacked thin layers.

40. Fabrication process of a standard micro-component according to claim 38, comprising deposition of a protective thin layer after exposure.
